(19) United States
(12) Patent Application Publication
(10) Pub. No.: US 2018/0183289 A1
(43) Pub. Date: Jun. 28, 2018

(54) ROTARY ELECTRIC MACHINE AND VEHICLE

(71) Applicant: Kabushiki Kaisha Toshiba, Minato-ku (JP)

(72) Inventors: Yosuke HORIUCHI, Ota (JP); Shinya SAKURADA, Shinagawa (JP); Makoto MATSUSHITA, Fuchu (JP); Norio TAKAHASHI, Yokohama (JP); Toshio HASEBE, Hachioji (JP); Tadashi TOKUMASU, Setagaya (JP); Keiko OKAMOTO, Kawasaki (JP)

(73) Assignee: Kabushiki Kaisha Toshiba, Minato-ku (JP)

(21) Appl. No.: 15/903,518

(22) Filed: Feb. 23, 2018

Related U.S. Application Data
(63) Continuation of application No. PCT/JP2016/084487, filed on Nov. 21, 2016.

(30) Foreign Application Priority Data
Sep. 16, 2016 (JP) 2016-182356

(51) Int. Cl. H02K 1/27; H02K 15/03; H01F 41/02; H02P 6/08; H02K 21/02; H02K 1/24

(52) U.S. Cl. CPC H02K 1/2773; H02K 1/278; H02K 15/03; H02K 1/24; H02P 6/08; H02K 1/2786; H02K 21/028; H01F 41/0293

(57) ABSTRACT

According to embodiments, an electric machine includes a shaft, a rotor core, and a plurality of permanent magnets. The shaft rotates about an axis thereof. The rotor core is fixed to the shaft. The plurality of permanent magnets are provided in the rotor core, and include at least a first permanent magnet and a second permanent magnet. The first permanent magnet has an intrinsic coercive force of 1200 [kA/m] or more. The second permanent magnet has an intrinsic coercive force of 800 [kA/m] or more, a residual magnetization substantially the same as or larger than that of the first permanent magnet, and a recoil permeability smaller than that of the first permanent magnet.

### CROSS REFERENCE TO RELATED APPLICATION

This application is a continuation patent application of International Application No. PCT/JP2016/084487, filed Nov. 21, 2016, which claims priority to Japanese Patent Application No. 2016-182356, filed Sep. 16, 2016. Both applications are hereby expressly incorporated by reference herein in their entireties.

### FIELD

Embodiments described herein relate generally to a rotary electric machine and a vehicle.

### BACKGROUND

Conventionally, in a rotary electric machine used as a power generator or an electric motor, a technology in which a plurality of permanent magnets of different types are provided in a rotor is known. In such a rotary electric machine, improvement in efficiency is desired.

### BRIEF DESCRIPTION OF THE DRAWINGS

FIG. 1 is a cross-sectional view perpendicular to a rotating shaft 8 showing a configuration of one pole of a four pole rotary electric machine 1 in first embodiments.

FIG. 2 is a view showing an arrangement example of a first permanent magnet 21 and a second permanent magnet 22.

FIG. 3 is a view showing an example of magnetic characteristics according to types of permanent magnet 20.

FIG. 4 is a view in which magnetic characteristics according to types of the permanent magnet 20 are expressed by an index of magnetization or a magnetic flux density.

FIG. 5 is a cross-sectional view perpendicular to a rotating shaft 8 showing a configuration of one pole of a four pole rotary electric machine 1A in second embodiments.

FIG. 6 is a view for describing demagnetization characteristics of a permanent magnet.

FIG. 7 is a view showing an arrangement example of a first permanent magnet 21 and a second permanent magnet 22 in third embodiments.

FIG. 8 is a view showing another arrangement example of the first permanent magnet 21 and the second permanent magnet 22 in third embodiments.

FIG. 9 is a view listing other arrangement examples of the first permanent magnet 21 and the second permanent magnet 22 in third embodiments.

FIG. 10 is a view for describing heat resistance of a permanent magnet.

FIG. 11 is a view showing an example of demagnetization characteristics of permanent magnets of various types having different heat resistant temperatures T.

FIG. 12 is a view showing an example of a railway vehicle 100 on which the rotary electric machine 1, 1A, or 1B is mounted.

FIG. 13 is a view showing an example of an automobile 200 on which the rotary electric machine 1, 1A, or 1B is mounted.

### DETAILED DESCRIPTION

According to embodiments, an electric machine includes a shaft, a rotor core, and a plurality of permanent magnets. The shaft rotates about an axis thereof. The rotor core is fixed to the shaft. The plurality of permanent magnets are provided in the rotor core, and include at least a first permanent magnet and a second permanent magnet. The first permanent magnet has an intrinsic coercive force of 1200 [kA/m] or more. The second permanent magnet has an intrinsic coercive force of 800 [kA/m] or more, a residual magnetization substantially the same as or larger than that of the first permanent magnet, and a recoil permeability smaller than that of the first permanent magnet.

Hereinafter, a rotary electric machine and a vehicle of embodiments will be described with reference to the drawings.

### First Embodiments

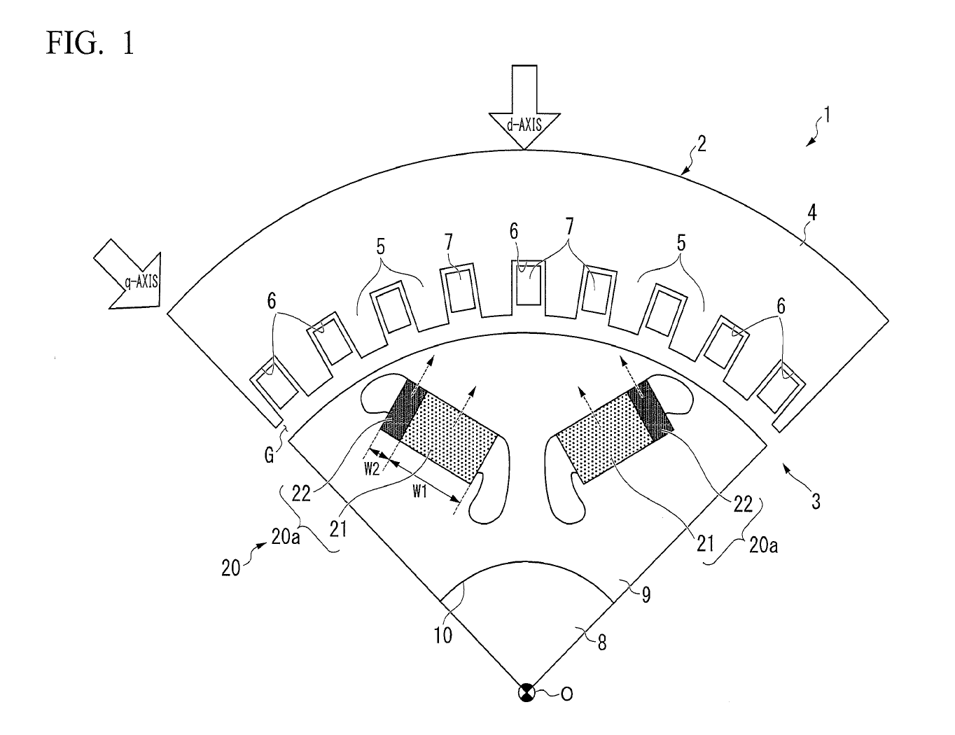

FIG. 1 is a cross-sectional view perpendicular to a rotating shaft 8 showing a configuration of one pole of a four pole rotary electric machine 1 in first embodiments. In FIG. 1, only one pole of the rotary electric machine 1, that is, only a quarter-circumference of a circumferential angular region is illustrated. Further, the number of magnetic poles is not limited to four, and may be three or less, or five or more. The rotating shaft 8 is, for example, a shaft rotatably supported, extending in an axial direction at a center of a rotor (rotor) 3, and rotating around the center of the rotor 3.

As illustrated in FIG. 1, the rotary electric machine 1 includes a stator (stator) 2 and the rotor 3 provided on a radial inner side with respect to the stator 2 and provided to be rotatable with respect to the stator 2. Further, the stator 2 and the rotor 3 are disposed in a state in which central axes thereof are positioned on a common axis. Hereinafter, the above-described common axis will be referred to as a central axis O, a direction perpendicular to the central axis O will be referred to as a radial direction, and a direction of revolving around the central axis O will be referred to as a circumferential direction.

The stator 2 includes a substantially cylindrical stator core 4. The stator core 4 can be formed by stacking a plurality of electromagnetic steel sheets or by compression-molding a soft magnetic powder. On an inner circumferential surface of the stator core 4, a plurality of teeth 5 protruding toward the central axis O and arranged at regular intervals in the circumferential direction are integrally molded. The teeth 5 are formed to have a substantially rectangular cross section. Also, slots 6 are formed respectively between the adjacent teeth 5. Through these slots 6, an armature winding 7 is wound around each tooth 5.

The armature winding 7 is connected to a power supply system (not illustrated) provided outside the rotary electric machine 1. The power supply system uses, for example, an inverter to supply power necessary for driving the rotary electric machine 1 to the armature winding 7. Thereby, current flows through the armature winding 7, and a magnetic field (magnetic field) is generated in the stator 2.

On the stator core 4, an insulator having an insulating property may be attached or the entire outer surface may be covered with an insulating film (none of them is illustrated). In this case, the armature winding 7 is wound around each tooth 5 from above the insulator or the insulating film.

The rotor 3 includes the rotating shaft 8 extending along the central axis O and a substantially columnar rotor core 9 externally fitted and fixed (connected) to the rotating shaft 8. The rotor core 9 can be formed by stacking a plurality of electromagnetic steel sheets or by compression-molding a soft magnetic powder. An outer diameter of the rotor core 9 is set such that a predetermined air gap G is formed between the rotor core 9 and each of the teeth 5 facing each other in the radial direction.

Also, a through hole 10 passing through the central axis O is formed at a radial center of the rotor core 9. The rotating shaft 8 is press-fitted or the like to the through hole 10. Thereby, the rotating shaft 8 and the rotor core 9 rotate integrally.

Further, a permanent magnet 20 is provided for each one pole (that is, quarter-circumference of circumferential angular region) in the rotor core 9. The permanent magnets 20 include, for example, a plurality of magnet sets 20a. Each of the magnet sets 20a includes a first permanent magnet 21 and a second permanent magnet 22. In addition, each magnet set 20a may include another permanent magnet different from the first permanent magnet 21 and the second permanent magnet 22.

For example, a cavity is formed in the rotor core 9, and the permanent magnet 20 is inserted into the cavity. As in the illustrated example, the plurality of magnet sets 20a included in the permanent magnets 20 are provided, for example, separately in two places which are axisymmetric with respect to a diameter (a straight line passing through the central axis O) of the rotor core 9 for each pole. At this time, a diameter between the plurality of magnet sets 20a is defined as a d-axis. Also, a direction magnetically perpendicular to the d-axis is defined as a q-axis. When a positive magnetic potential is given to a circumferential angular position A on an outer circumferential surface of the rotor core 9, for example, by bringing the north pole of a magnet close thereto and a negative magnetic potential is given to a circumferential angular position B shifted by one pole (90 degrees in this embodiments) with respect to the position A, for example, by bringing the south pole of the magnet close thereto, the q-axis is defined as a direction from the central axis O toward the position A when a majority of the magnetic flux flows when the position A is shifted in the circumferential direction on the outer circumferential surface of the rotor core 9.

The first permanent magnet 21 is, for example, a rare earth magnet, and a composition formula thereof is RpFeqMrCutCo100-p-q-r-s-t. Here, R represents at least one element selected from rare earth elements such as samarium Sm, Fe represents the element iron, M represents at least one element selected from titanium Ti, zirconium Zr, and hafnium Hf, Cu represents the element copper, and Co represents the element cobalt. Also, each of p, q, r, s and tin the composition formula represents an atomic composition percentage [at %]. For example, the first permanent magnet 21 is formed to satisfy the following relationships (a) to (d).

(a): 10.8≤p≤11.6

(b): 25≤q≤40

(c): 0.88≤r≤4.5

(d): 0.88≤t≤13.5

For example, the first permanent magnet 21 may be a samarium cobalt magnet in which samarium Sm is adopted as R. A recoil permeability of the first permanent magnet 21 is, for example, 1.1 or more. Also, a residual magnetization B1 of the first permanent magnet 21 is 1.16 [T: Tesla] or more. Further, an intrinsic coercive force Hcj1 of the first permanent magnet 21 is 1200 [kA/m] or more. Here, the intrinsic coercive force Hcj represents an intensity of a magnetic field for making a magnetic polarization inherently possessed by the permanent magnet 20 zero.

The second permanent magnet 22 is, for example, a rare earth magnet similarly to the first permanent magnet 21, and a composition formula thereof is RsTuBv. Here, R represents at least one element selected from rare earth elements, T includes iron or at least one element selected from cobalt, nickel, copper, aluminum, zinc, silicon, gadolinium, and gallium, and B represents the element boron. s and v in the composition formula respectively represent atomic composition percentages [at %].

Also, T may have a one-to-one composition as in a combination of iron and cobalt, or may have a one-to-many composition as in a combination of iron, cobalt, nickel and copper. For example, the second permanent magnet 22 is formed to satisfy the following relationships (e) to (g).

(e): 10≤s≤25

(f): 2≤q≤20

(g): u=100−s−v

For example, the second permanent magnet 22 may be a neodymium magnet in which neodymium Nd is adopted as R. A recoil permeability of the second permanent magnet 22 is 1.1 or less and is a smaller value than the recoil permeability of the first permanent magnet 21. Also, a residual magnetization B2 of the second permanent magnet 22 is 1.16 [T] or more and is a larger value than the residual magnetization B1 of the first permanent magnet 21. In addition, an intrinsic coercive force Hcj2 of the second permanent magnet 22 is 800 [kA/m] or more.

For example, the first permanent magnet 21 and the second permanent magnet 22 may form a magnetic circuit inside the rotor core 9 and be disposed in a parallel relationship or in a series relationship with respect to each other on the magnetic circuit. The first permanent magnet 21 and the second permanent magnet 22 form the same rotor magnetic pole as each other. In an example of FIG. 1, the second permanent magnet 22 is provided on an outer circumferential side of the rotor core 9 with respect to the first permanent magnet 21 to be connected in parallel to the first permanent magnet 21 on the magnetic circuit. For example, the first permanent magnet 21 and the second permanent magnet 22 may be inserted into a common cavity. When the first permanent magnet 21 and the second permanent magnet 22 are inserted into a common cavity, these magnets may be in contact with each other in the cavity, or a nonmagnctic material such as an adhesive resin or a spacer may be interposed therebetween. Also, the first permanent magnet 21 and the second permanent magnet 22 may be respectively inserted into separate cavities. A magnetization direction (indicated by a broken line arrow in the figure) of each of the first permanent magnet 21 and the second permanent magnet 22 is directed toward the outer circumferential surface of the rotor core 9 in the one pole of the rotor core 9 in which these magnets are provided. The magnetization direction represents a direction (magnetization easy axis) in which the magnet is easily magnetized in consideration of magnetocrystalline anisotropy of the permanent magnet.

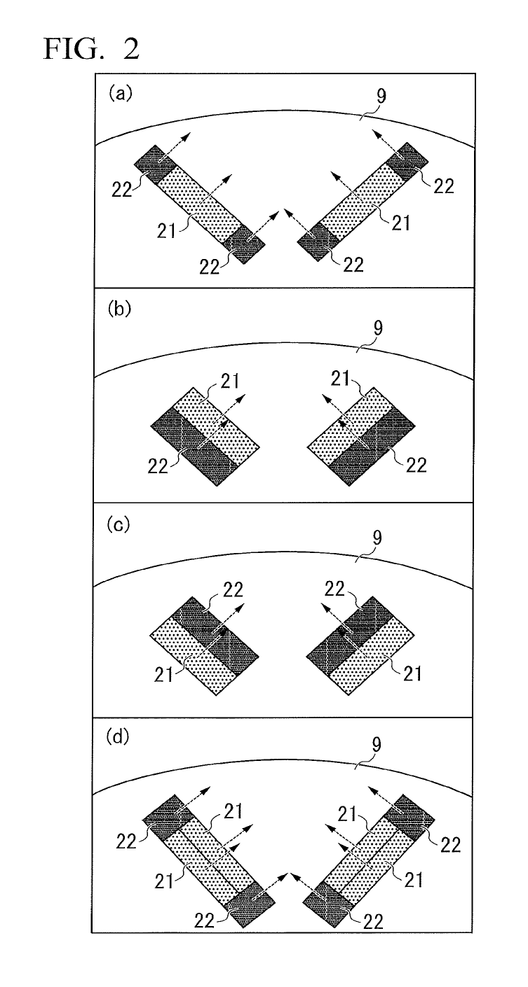

FIG. 2 is a view showing an arrangement example of the first permanent magnet 21 and the second permanent magnet 22. For example, in figure (a) in the drawing, second permanent magnets 22 are provided on both an outer circumferential side and an inner circumferential side of the rotor core 9 when viewed from the first permanent magnet 21 to be connected in parallel to the first permanent magnet 21 on the magnetic circuit. In figure (b) in the drawing, the second permanent magnet 22 is provided on the inner circumferential side of the rotor core 9 when viewed from the first permanent magnet 21 to be connected in series to the first permanent magnet 21 on the magnetic circuit. In figure (c), the second permanent magnet 22 is provided on the outer circumferential side of the rotor core 9 when viewed from the first permanent magnet 21 to be connected in series to the first permanent magnet 21 on the magnetic circuit. In figure (d) in the drawing, two first permanent magnets 21 are provided to be connected in series to each other on the magnetic circuit, and second permanent magnets 22 are provided on both the outer circumferential side and the inner circumferential side of the rotor core 9 when viewed from the two first permanent magnets 21 to be connected in parallel to the first permanent magnets 21 on the magnetic circuit.

For example, when heat resistance of the rotary electric machine 1 is considered, since a temperature on the outer circumferential side of the rotor core 9 easily rises under the influence of external disturbances or the like as compared with that on the inner circumferential side thereof, it is preferable to dispose the first permanent magnet 21 which is superior in heat resistance on the outer circumferential side of the rotor core 9 with respect to the second permanent magnet 22. On the other hand, when mechanical strength of the rotary electric machine 1 is considered, since a stress due to a centrifugal force on the outer circumferential side of the rotor core 9 easily increases as compared with that on the inner circumferential side thereof, it is preferable to dispose the second permanent magnet 22 having a higher density on the outer circumferential side of the rotor core 9 with respect to the first permanent magnet 21. As described above, an arrangement relationship between the first permanent magnet 21 and the second permanent magnet 22 may be appropriately changed according to evaluation indexes to be considered at the time of designing the rotary electric machine 1.

As described above, it is possible to increase a total amount of magnetic flux linkage Φ by providing the first permanent magnet 21 and the second permanent magnet 22 having a residual magnetization different from each other on the rotor core 9. Among magnetic fluxes generated from the first permanent magnet 21 and the second permanent magnet 22, the magnetic flux linkage Φ a magnetic flux that faces in a d-axis direction and links with the armature winding 7 via the air gap G For example, the magnetic flux linkage Φ can be derived from the following expression (1).

### [Math. 1]

Φ=BS∝B₁W₁+B₂W₂+ . . . (1)

In the expression, B represents magnetization (magnetic flux density) in the rotor core 9, and S represents a cross-sectional area of the permanent magnet 20. The cross-sectional area of the permanent magnet 20 is an area of the permanent magnet 20 in a plane parallel to a direction in which the rotating shaft 8 extends along an axis thereof. For example, when the permanent magnet is a cuboid, the cross-sectional area of the permanent magnet 20 is an area of the permanent magnet 20 in a plane perpendicular to the magnetization direction (magnetization easy axis). A product of the magnetic flux density B of the rotor core 9 and a cross-sectional area S of the permanent magnet 20 is proportional to a sum of products of a width Wi of each permanent magnet (the first permanent magnet 21, the second permanent magnet 22, . . . ) included in the permanent magnet 20 and a residual magnetization (residual magnetic flux density) Bi of each permanent magnet. The width Wi of each permanent magnet is a size in a direction substantially perpendicular to the magnetization direction of the permanent magnet. W1 in FIG. 1 represents a width of the first permanent magnet 21 and W2 represents a width of the second permanent magnet 22.

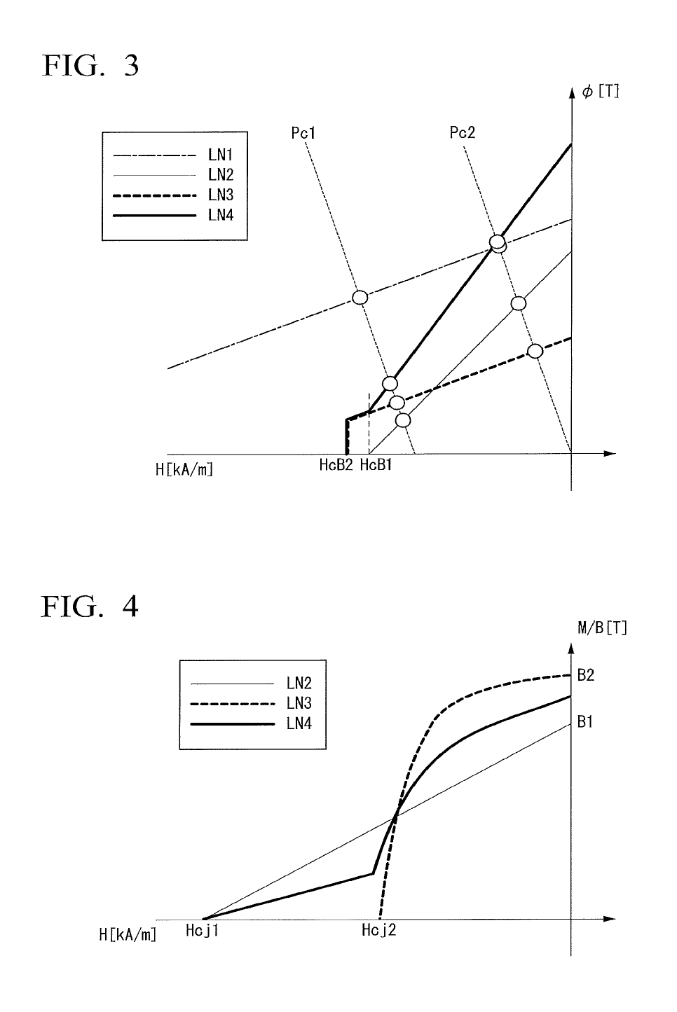

FIG. 3 is a view showing an example of magnetic characteristics according to types of the permanent magnet 20. In the figure, the vertical axis represents magnetic flux Φ (unit is [T]), and the horizontal axis represents magnetic field strength H (unit is [kA/m]). Magnetic characteristics represented by these axes represent demagnetization characteristics (a second quadrant of a hysteresis curve). In the figure, HcB1 is a coercive force corresponding to an intrinsic coercive force Hcj1 of the first permanent magnet 21, and HcB2 is a coercive force corresponding to an intrinsic coercive force Hcj2 of the second permanent magnet 22. These coercive forces HcB1 and HcB2 indicate the strength of a magnetic field corresponding to zero magnetic flux density on the B-H demagnetization curve. In other words, this is the strength of a magnetic field at which magnetization of the whole magnetic circuit in which an applied external magnetic field and the magnetization of the permanent magnet are combined becomes zero.

Line LN1 represents magnetic characteristics in a case in which a permanent magnet having a large residual magnetization and a small intrinsic coercive force as compared with the first permanent magnet 21 and the second permanent magnet 22 is provided in the rotor core 9. Line LN2 represents magnetic characteristics in a case in which the first permanent magnet 21 is provided in the rotor core 9. Line LN3 represents magnetic characteristics in a case in which the second permanent magnet 22 is provided in the rotor core 9. Line LN4 represents magnetic characteristics in a case in which the first permanent magnet 21 and the second permanent magnet 22 are provided in the rotor core 9. As illustrated in the drawing, magnetic flux Φ represented by the line LN4 is a sum of the magnetic flux Φ represented by the line LN2 and the magnetic flux Φ represented by the line LN3 on the basis of the above-described expression (1).

Line Pc1 represents permeance characteristics when a rotation speed of the rotor 3 is a predetermined speed or more (hereinafter referred to as high-speed rotation). Line Pc2 represents permeance characteristics when the rotation speed of the rotor 3 is less than the predetermined speed (hereinafter referred to as low-speed rotation). Operating points of the rotary electric machine 1 at the time of high-speed rotation are intersection points of the lines LN1 to LN4 indicating the respective magnetic characteristics and the line Pc1. Also, operating points of the rotary electric machine 1 at the time of low-speed rotation are intersection points of the lines LN1 to LN4 indicating the respective magnetic characteristics and the line Pc2.

For example, when a state of the rotary electric machine 1 is shifted from low-speed rotation to high-speed rotation or when maintaining the high-speed rotation state, the controller (not illustrated) which controls the rotary electric machine 1 causes a power supply system to supply power to the armature winding 7 to generate a magnetic field in the stator 2, thereby performing control of weakening a magnetic field H (field-weakening control). The magnetic field generated in the stator 2 is a reverse magnetic field (a magnetic field whose magnetization direction is in the opposite direction) to the magnetic field generated by the permanent magnet 20 of the rotor 3. Also, when the state of the rotary electric machine 1 is shifted from the high-speed rotation to the low-speed rotation or when maintaining the low-speed rotation state, the controller reduces an amount of power (amount of current for weakening field) supplied from the power supply system to the armature winding 7, and performs magnetic field control to weaken the strength of the magnetic field generated in the stator 2.

As illustrated in FIG. 3, for example, when a magnet of a comparison object is provided in the rotor core 9 (when focusing on the line LN1), although a relatively large magnetic flux Φ is generated due to a large residual magnetization at the operating point of the rotary electric machine 1 at the time of low-speed rotation, there are some cases in which the magnetic flux Φ is not sufficiently lowered due to the small intrinsic coercive force at the operating point of the rotary electric machine 1 at the time of high-speed rotation. For this reason, there are some cases in which efficiency (for example, a ratio of the rotation speed or a torque to the amount of the power supplied to the stator 2) decreases due to an influence of a counter electromotive force or the like generated at the time of high-speed rotation. In addition, there may be cases in which a difference in magnetic flux between the low-speed rotation and the high-speed rotation becomes small and accuracy of the field-weakening control decreases. As a result, energy loss during control tends to increase.

In addition, when only the first permanent magnet 21 is provided in the rotor core 9 (when focusing on the line LN2), although the magnetic flux Φ can be further lowered due to the large intrinsic coercive force at the operating point of the rotary electric machine 1 at the time of high-speed rotation as compared with the case in which the magnet of the comparison object is provided in the rotor core 9, the magnetic flux Φ is lowered due to the small residual magnetization at the operating point of the rotary electric machine 1 at the time of the low-speed rotation. As a result, the torque at the time of the low-speed rotation decreases and efficiency tends to decrease.

In contrast, when the first permanent magnet 21 and the second permanent magnet 22 are provided in the rotor core 9 (when focusing on the line LN4) as in the present embodiments, a relatively large magnetic flux Φ can be generated at the operating point of the rotary electric machine 1 at the time of low-speed rotation as in the case in which the magnet of the comparison object is provided in the rotor core 9. In addition, the magnetic flux Φ can be further lowered due to the large intrinsic coercive force at the operating point of the rotary electric machine 1 at the time of high-speed rotation as compared with the case in which the magnet of the comparison object is provided in the rotor core 9. Thus, it is possible to suppress generation of the counter electromotive force at the time of high-speed rotation and to improve the torque at the time of low-speed rotation. Further, accuracy of the field-weakening control can be improved. As a result, energy loss can be suppressed at both the low-speed rotation and the high-speed rotation, and thus efficiency can be improved.

FIG. 4 is a view in which magnetic characteristics according to types of the permanent magnet 20 are expressed by an index of magnetization or a magnetic flux density. In the figure, the vertical axis represents magnetization M or the magnetic flux density B (each unit is [T]) and the horizontal axis represents the magnetic field strength H (unit is [kA/m]).

When the first permanent magnet 21 and the second permanent magnet 22 are provided in the rotor core 9 (in the case of focusing on the line LN4) as in the present embodiments, a residual magnetization of the magnet set 20a including these permanent magnets (value of an intercept on the M or B axis of the line LN4) is an average of the residual magnetization B1 of the first permanent magnet 21 and the residual magnetization B2 of the second permanent magnet 22. In the present embodiments, since the residual magnetization B1 and the residual magnetization B2 are set to different values from each other, the magnetic flux Φ at the operating point of the rotary electric machine 1 at the time of high-speed rotation tends to decrease and the magnetic flux Φ at the operating point of the rotary electric machine 1 at the time of low-speed rotation tends to increase.

According to the rotary electric machine 1 of first embodiments described above, since a plurality of permanent magnets 20 provided in the rotor core 9 include at least the first permanent magnet 21 having an intrinsic coercive force of 1200 [kA/m] or more, and the second permanent magnet 22 having an intrinsic coercive force of 800 [kA/m] or more, having a residual magnetization substantially equal to or larger than that of the first permanent magnet 21, and having a recoil permeability smaller than that of the first permanent magnet 21, it is possible to improve efficiency.

Further, according to the rotary electric machine 1 of first embodiments described above, since the intrinsic coercive force of the first permanent magnet 21 and the second permanent magnet 22 are large, the magnetic flux 1 can be further lowered at the operating point of the rotary electric machine 1 at the time of high-speed rotation. As a result, generation of a counter electromotive force at the time of high-speed rotation can be suppressed.

In addition, according to the rotary electric machine 1 of first embodiments described above, since the second permanent magnet 22 having the residual magnetization B2 larger than the residual magnetization B1 of the first permanent magnet 21 is provided, it is possible to further increase the magnetic flux Φ at the operating point of the rotary electric machine 1 at the time of low-speed rotation. As a result, the torque at the time of low-speed rotation can be improved.

### Second Embodiments

Hereinafter, a rotary electric machine 1A according to second embodiments will be described. The rotary electric machine 1A in second embodiments differs from the rotary electric machine 1 of first embodiments in that a second permanent magnet 22 is separately provided in addition to a magnet set 20a including a first permanent magnet 21 and a second permanent magnet 22. Hereinafter, this difference will be mainly described and a description of common portions will be omitted.

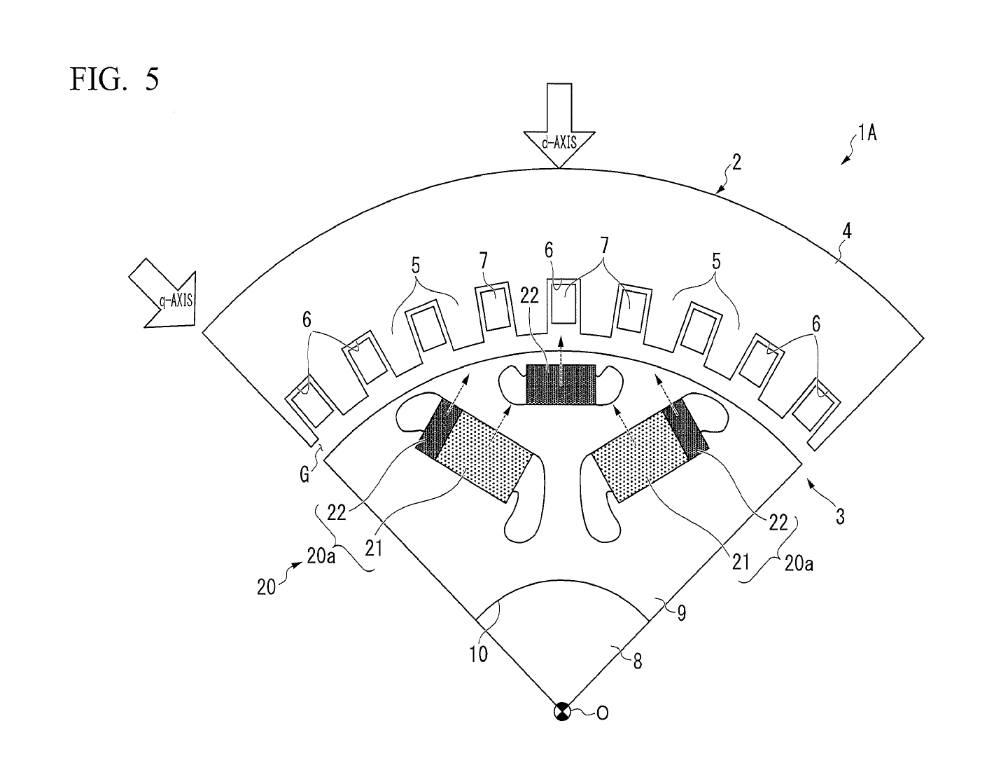

FIG. 5 is a cross-sectional view perpendicular to a rotating shaft 8 showing a configuration of one pole of the four pole rotary electric machine 1A in second embodiments. As illustrated in the drawing, the magnet sets 20a having the first permanent magnet 21 and the second permanent magnet 22 paired together provided at two places axisymmetric with respect to a d-axis, and the second permanent magnet 22 on the d-axis, are provided in a rotor core 9. Thereby, the magnet set 20a having the first permanent magnet 21 and the second permanent magnet 22 paired together and the second permanent magnet 22 on the d-axis are fixed in series on a magnetic circuit. As a result, as in the above-described embodiments, it is possible to improve efficiency and to output a larger torque at the time of low-speed rotation.

### Third Embodiments

Hereinafter, a rotary electric machine 1B in third embodiments will be described. The rotary electric machine 1B of third embodiments differs from the rotary electric machine 1 of first embodiments and the rotary electric machine 1A of second embodiments in that arrangement positions of these magnets are determined in consideration of both demagnetization characteristics and heat resistance of the first permanent magnet 21 and the second permanent magnet 22 provided in the rotary electric machine 1B. Hereinafter, this difference will be mainly described and a description of common portions will be omitted.

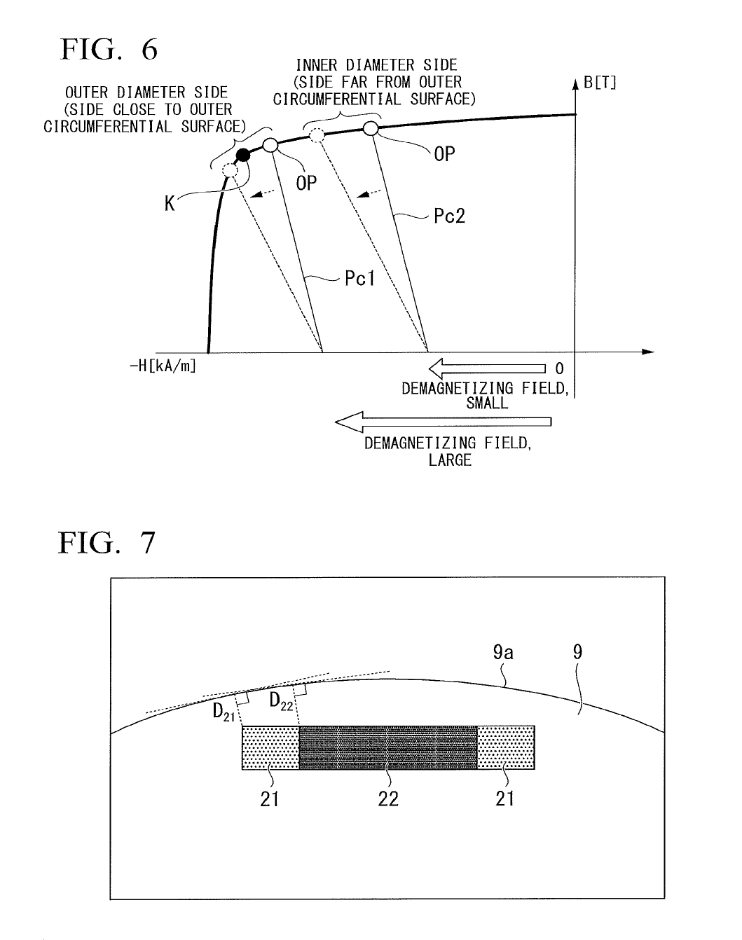

First, an arrangement example of the first permanent magnet 21 and the second permanent magnet 22 in consideration of the demagnetization characteristics will be described. FIG. 6 is a view for describing demagnetization characteristics of a permanent magnet. In the figure, the vertical axis represents a magnetic flux density B (unit is [T]) and the horizontal axis represents magnetic field strength H (unit is [kA/m]). Magnetic characteristics represented by these axes represent demagnetization characteristics (a second quadrant of a hysteresis curve).

In general, since a magnetic flux tends to be concentrated on corner portions (corners) (for example, four corners when a cross-sectional shape of a magnet in a plane including a d-axis and a q-axis is a quadrangle) of the permanent magnet as compared with other portions, a demagnetizing field (demagnetizing field) tends to be generated around the corner portions. The corner portions are a corner portions in the plane including the d-axis and the q-axis. The corner portions may be rounded. The demagnetizing field refers to a magnetic field applied from a stator 2 to a rotor 3, and is an external magnetic field applied from the outside (the stator 2) when viewed from the rotor 3. This demagnetizing field tends to be generated at a permanent magnet having a smaller coercive force.

As illustrated in the drawing, a relatively small demagnetizing field is generated in permanent magnets provided on an inner diameter side (inner circumferential side), that is, on a side far from an outer circumferential surface of a rotor core 9. In contrast, a stronger demagnetizing field is generated in permanent magnets provided on an outer diameter side (outer circumferential side), that is, on a side closer to the outer circumferential surface of the rotor core 9 as compared with the demagnetizing field generated by the permanent magnets on the inner diameter side. At this time, an operating point OP of each of the permanent magnets on the inner diameter side and the outer diameter side shifts to a lower magnetic field side (a side in which the magnetic field H becomes more negative).

On the other hand, there are some cases in which a knick point (inflection point) K exists on a curve (B-H demagnetization curve) showing demagnetization characteristics. The knick point K refers to a point at which the demagnetization characteristics greatly change. As described above, when the operating point OP of a permanent magnet shifts to a low magnetic field side due to an influence of the demagnetizing field, there are some cases in which the operating point OP passes beyond the knick point K. In this case, irreversible demagnetization occurs, and the residual magnetization (residual magnetic flux density) of the permanent magnet decreases.

Therefore, in the present embodiments, the first permanent magnet 21 having no knick point K or having characteristics in which a position of the knick point K is on a higher magnetic field side is disposed on the outer diameter side which is easily affected by an external magnetic field and at which the demagnetizing field tends to be generated, and the second permanent magnet 22 is disposed on the inner diameter side. That is, the first permanent magnet 21 is disposed on the outer circumferential side of the rotor core 9 with respect to the second permanent magnet 22. From another viewpoint, the above-described arrangement method means that permanent magnets are disposed so that the first permanent magnet 21 is closer to the outer circumferential surface of the rotor core 9 as compared with the second permanent magnet 22.

For example, the permanent magnets may be disposed so that at least one corner portion among a plurality of corner portions of the first permanent magnet 21 is closer to the outer circumferential surface of the rotor core 9 than all the corner portions of the second permanent magnet 22.

FIG. 7 is a view showing an arrangement example of the first permanent magnets 21 and the second permanent magnet 22 in third embodiments. 9a indicated in the figure represents the outer circumferential surface of the rotor core 9. As illustrated in the drawing, when the cross-sectional shape of the first permanent magnets 21 and the second permanent magnet 22 in the plane including the d-axis and the q-axis is a quadrangular shape, and when distances from each of the corner portions of these permanent magnets to the outer circumferential surface 9a of the rotor core 9 are compared, the permanent magnets are disposed so that a distance D₂₁ from a corner portion of a first permanent magnet 21 to the outer circumferential surface 9a of the rotor core 9 is smaller than a distance D₂₂ from a corner portion of the second permanent magnet 22 to the outer circumferential surface 9a of the rotor core 9. The distance D₂₁ and the distance D₂₂ are perpendicular lines perpendicular to a tangent of the outer circumferential surface 9a of the rotor core 9 and are lengths of the perpendicular lines which come into contact with the corner portions of the respective permanent magnets at the shortest distance. For example, when the first permanent magnets 21 and the second permanent magnet 22 are arranged in a parallel relationship with respect to each other on the magnetic circuit, as illustrated in the drawing, the second permanent magnet 22 is disposed between the two first permanent magnets 21.

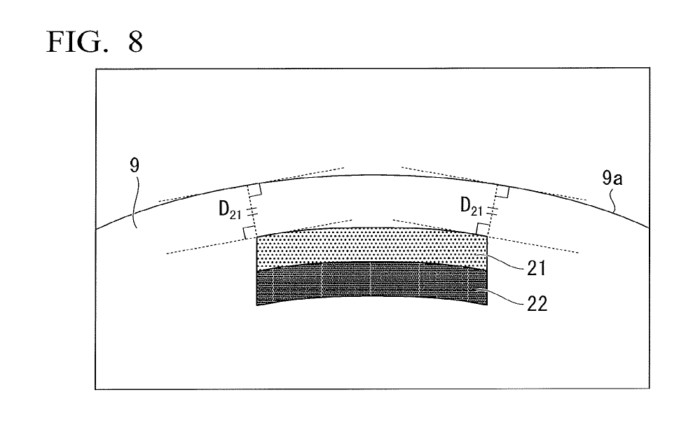

FIG. 8 is a view showing another arrangement example of the first permanent magnet 21 and the second permanent magnet 22. As illustrated in the drawing, when the first permanent magnet 21 and the second permanent magnet 22 are curved to the same extent as a curvature of the outer circumferential surface 9a of the rotor core 9, the first permanent magnet 21 is disposed closer to the outer circumferential surface 9a with respect to the second permanent magnet 22 so that the first permanent magnet 21 and the second permanent magnet 22 are in a series relationship with respect to each other (so as to be aligned in the radial direction).

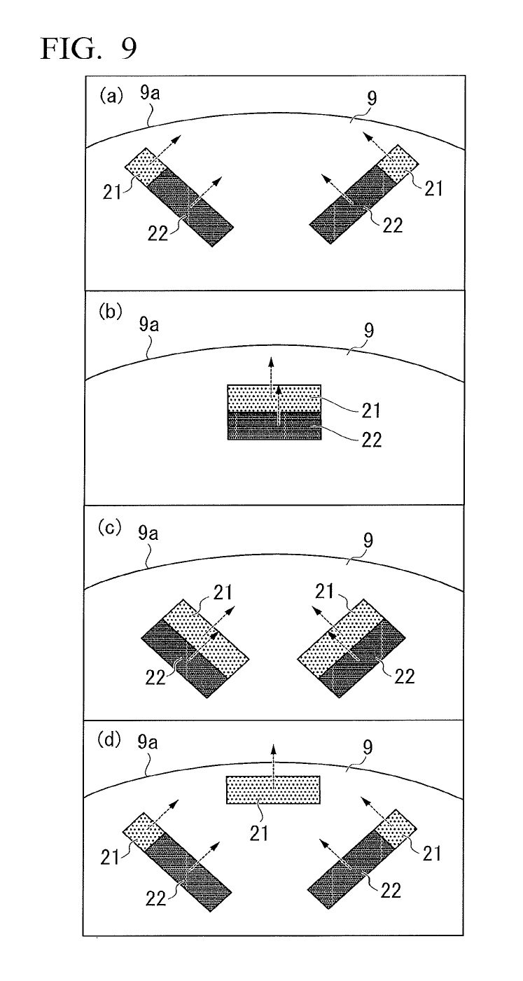

FIG. 9 is a view listing other arrangement examples of the first permanent magnet 21 and the second permanent magnet 22. In all of the arrangement examples illustrated from (a) to (d) in the figures, the first permanent magnet 21 is disposed on the outer circumference side of the rotor core 9 with respect to the second permanent magnet 22. Thereby, irreversible demagnetization can be suppressed even when a demagnetizing field is generated.

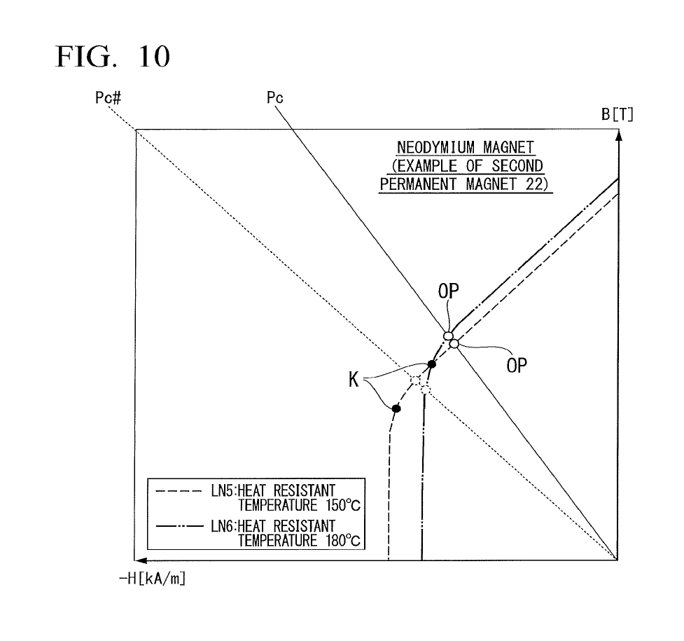

Next, a method of selecting the second permanent magnet 22 in consideration of heat resistance will be described. FIG. 10 is a view for describing heat resistance of a permanent magnet. In the figure, the vertical axis represents the magnetic flux density B (unit is [T]) and the horizontal axis represents the magnetic field strength H (unit is [kA/m]). The magnetic characteristics represented by the axes represent demagnetization characteristics (second quadrant of a hysteresis curve) of the neodymium magnet which has been described as an example of the second permanent magnet 22. In the figure, LN5 represents the demagnetization characteristics (B-H demagnetization curve) of the neodymium magnet with a heat resistant temperature T of 150 [° C.], and LN6 represents the demagnetization characteristics of the neodymium magnet with a heat resistant temperature T of 180 [° C.]. In the figure, Pc represents permeance characteristics before being demagnetized by the demagnetizing field, and Pc# represents permeance characteristics after demagnetization by the demagnetizing field.

As in the illustrated example, in general, the residual magnetization B and the heat resistant temperature T of a permanent magnet are in a tradeoff relationship, and a permanent magnet having a larger residual magnetization B has a lower heat resistant temperature T. On the other hand, since a demagnetizing field is generated as the heat resistant temperature T of a permanent magnet grows higher, the operating point OP of the permanent magnet easily passes beyond the knick point K and irreversible demagnetization is easily generated. Therefore, it is preferable to select a permanent magnet having a relatively low heat resistant temperature T in which the operating point OP does not pass beyond the knick point K under the demagnetizing field. In the example illustrated in the drawing, the neodymium magnet whose heat resistant temperature T is 150 [° C.] was selected.

In the present embodiments, since the first permanent magnet 21 having excellent heat resistance is disposed on the outer circumferential surface 9a side at which the temperature grows higher in the rotor core 9 and the second permanent magnet 22 is disposed on the inner diameter side having a temperature lower than that of the outer circumferential surface 9a side, a permanent magnet having a low heat resistant temperature T can be applied as the second permanent magnet 22 among a plurality of second permanent magnets 22 candidates having different heat resistant temperatures T.

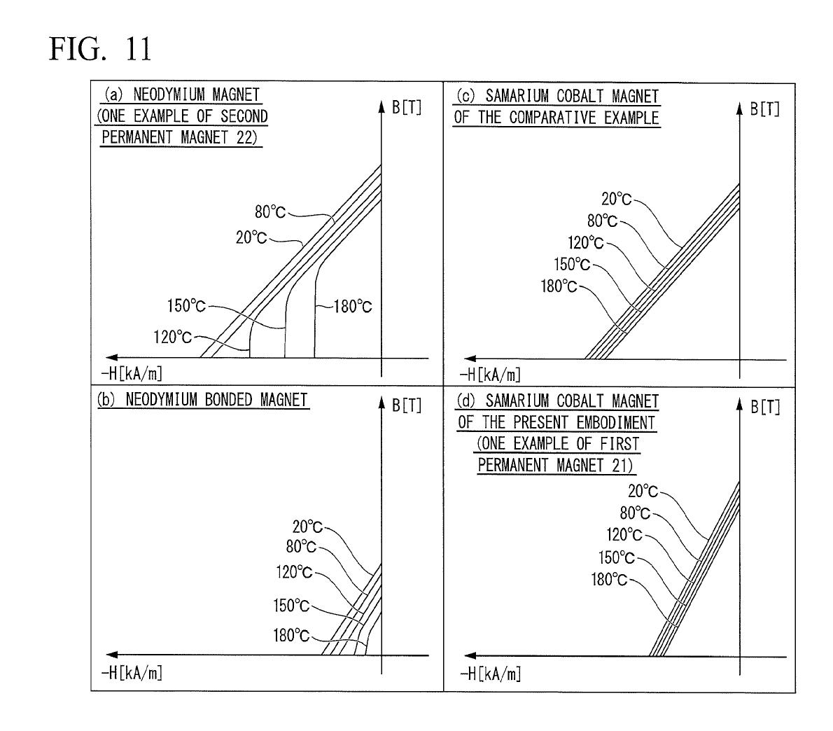

FIG. 11 is a view showing an example of demagnetization characteristics of permanent magnets of various types having different heat resistant temperatures T. Figure (a) in the drawing represents an example of demagnetization characteristics of the neodymium magnet which is an example of the second permanent magnet 22. Also, (b) represents an example of demagnetization characteristics of a neodymium bonded magnet. In addition, (c) represents an example of demagnetization characteristics of a samarium cobalt magnet as a comparative example. The samarium cobalt magnet exemplified as the comparative example, for example, has a smaller recoil relative magnetic permeability as compared with the recoil relative magnetic permeability of the first permanent magnet 21. That is, the samarium cobalt magnet exemplified as the comparative example is a permanent magnet whose inclination of the B-H demagnetization curve is smaller compared with that of the first permanent magnet 21. Also, (d) represents an example of demagnetization characteristics of a samarium cobalt magnet which is an example of the first permanent magnet 21 of the present embodiments. In all of (a) to (d), the vertical axis represents the magnetic flux density B (unit is [T]) and the horizontal axis represents the magnetic field strength H (unit is [kA/m]).

As illustrated in (a), for example, the residual magnetization of the neodymium magnet decreases as the heat resistant temperature T increases, and the knick point K appears at a higher magnetic field (on a side close to zero). In addition, in the neodymium magnet, an influence of the knick point K (magnitude of magnetization decreasing due to demagnetization) is larger than that in the neodymium bonded magnet illustrated in (b).

As illustrated in (b), for example, the residual magnetization of the neodymium bonded magnet decreases as the heat resistant temperature T increases, and the knick point K appears at a higher magnetic field. In addition, the neodymium bonded magnet has a smaller residual magnetization and intrinsic coercive force as compared with the other permanent magnets illustrated in (a), (c) and (d).

As illustrated in (c), for example, the residual magnetization of the samarium cobalt magnet of the comparative example decreases as the heat resistant temperature T increases. At this time, the knick point K does not appear at any heat resistant temperature T (20, 80, 120, 150, 180 [° C.]) assumed under the usage environment.

As illustrated in (d), for example, the residual magnetization of the samarium cobalt magnet of the present embodiments decreases as the heat resistant temperature T increases. At this time, similarly to (c) described above, the knick point K docs not appear at any heat resistant temperature T (20, 80, 120, 150, 180 [° C.]) assumed under the usage environment.

As described above, since the knick point K does not appear even when the samarium cobalt magnet which is an example of the first permanent magnet 21 has a heat resistant temperature of about 180° C., generation of the irreversible demagnetization can be suppressed even when the samarium cobalt magnet is disposed on the outer circumferential side of the rotor core 9. On the other hand, since the neodymium magnet which is an example of the second permanent magnet 22 is provided on the inner diameter side having a lower temperature than the outer circumferential side, a magnet having a relatively low heat resistant temperature T such as 80° C. or 120° C. can be adopted as the second permanent magnet 22. As a result, since it is possible to use the second permanent magnet 22 having a relatively large residual magnetization B, performance (for example, maximum output, efficiency, or the like) of the rotary electric machine 1B can be improved.

According to the rotary electric machine 1B of third embodiments described above, as in first and second embodiments described above, generation of the counter electromotive force at the time of high-speed rotation can be suppressed and the torque at the time of low-speed rotation can be improved.

According to the rotary electric machine 1B of third embodiments described above, when the first permanent magnet 21 having excellent heat resistance is disposed on the outer circumferential side of the rotor core 9 with respect to the second permanent magnet 22, it is possible to suppress demagnetization generated at the time of high temperature. Also, since the intrinsic coercive force Hcj1 of the first permanent magnet 21 is larger than the intrinsic coercive force Hcj2 of the second permanent magnet 22, demagnetization caused by the concentration of the magnetic flux on corner portions of the first permanent magnet 21 can be suppressed. In addition, since the second permanent magnet 22 is disposed on the inner diameter side with respect to the first permanent magnet 21, a magnet having a relatively low heat resistant temperature T can be applied as the second permanent magnet 22. As a result, since it is possible to use the second permanent magnet 22 having a relatively large residual magnetization B, performance (for example, maximum output, efficiency, and the like) of the rotary electric machine 1B can be improved.

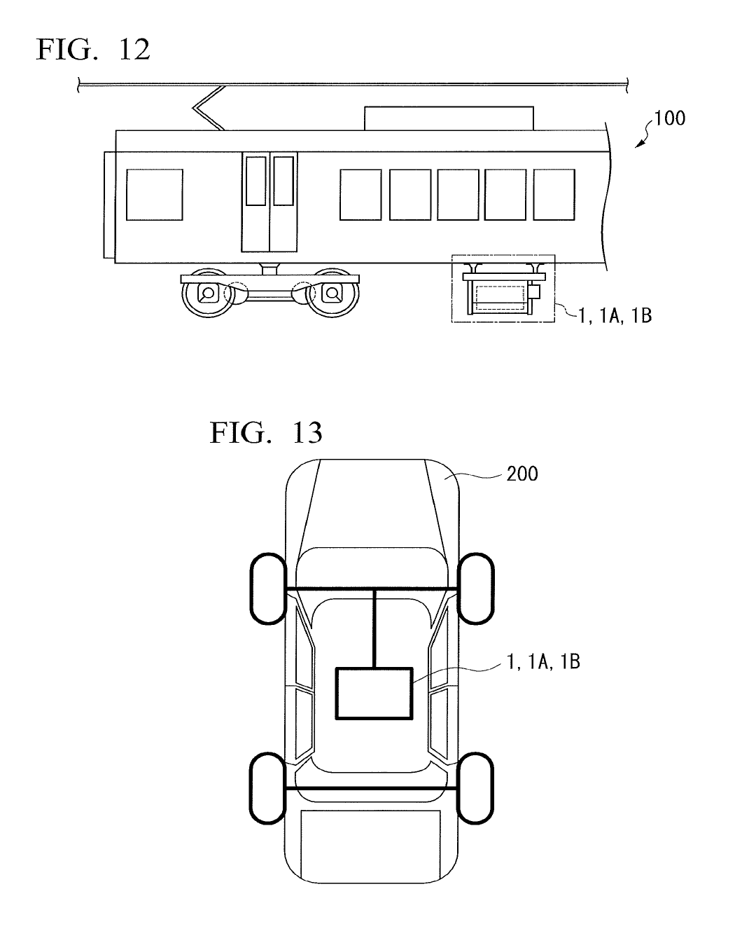

The rotary electric machine 1 in first embodiments, the rotary electric machine 1A in second embodiments, and the rotary electric machine 1B in third embodiments described above may be, for example, mounted on a railway vehicle 100 (an example of a vehicle) used for railway transportation. FIG. 12 is a view showing an example of the railway vehicle 100 on which the rotary electric machine 1, 1A, or 1B is mounted. As illustrated in the drawing, when the rotary electric machine 1, 1A, or 1B is mounted on the railway vehicle 100, the rotary electric machine 1, 1A, 1B, for example, may be used as an electric motor (motor) which outputs a driving force by using power supplied from an overhead line or power supplied from a secondary battery mounted on the railway vehicle 100, and may be used as a power generator (generator) which converts kinetic energy into electric power for supplying the electric power to loads of various types in the railway vehicle 100. Thereby, since the highly efficient rotary electric machine 1, 1A, or 1B is used, it is possible to cause the railway vehicle to travel in an energy saving state.

Further, the rotary electric machine 1, 1A, or 1B may be mounted on an automobile (another example of a vehicle) such as a hybrid automobile or an electric automobile. FIG. 13 is a view showing an example of the automobile 200 on which the rotary electric machine 1, 1A, or 1B is mounted. As illustrated in the drawing, when the rotary electric machine 1, 1A, or 1B is mounted on the automobile 200, the rotary electric machine 1, 1A, or 1B may be used as an electric motor which outputs a driving force of the automobile 200, or as a power generator which converts kinetic energy during traveling of the automobile 200 into electric power.

According to at least one embodiments described above, the plurality of permanent magnets provided in the rotor core 9 include at least the first permanent magnet 21 which has an intrinsic coercive force of 1200 [kA/m] or more and the second permanent magnet 22 which has an intrinsic coercive force of 800 [kA/m] or more, whose residual magnetization is substantially the same as or larger than that of the first permanent magnet 21, and whose recoil permeability is smaller than that of the first permanent magnet 21, and thereby efficiency can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rotary electric machine comprising:
a shaft rotating about an axis thereof;
a rotor core fixed to the shaft; and
a plurality of permanent magnets provided in the rotor core, wherein the plurality of permanent magnets include at least:
a first permanent magnet which has an intrinsic coercive force of 1200 [kA/m] or more; and
a second permanent magnet which has an intrinsic coercive force of 800 [kA/m] or more, whose residual magnetization is substantially the same as or larger than that of the first permanent magnet, and whose recoil permeability is smaller than that of the first permanent magnet.

2. The rotary electric machine according to claim 1, wherein the first permanent magnet and the second permanent magnet are disposed to correspond to the same rotor magnetic pole.

3. The rotary electric machine according to claim 1, wherein the first permanent magnet and the second permanent magnet are magnetically disposed in parallel or in series.

4. The rotary electric machine according to claim 1, wherein a residual magnetization of the first permanent magnet and the second permanent magnet is 1.16 [T] or more.

5. The rotary electric machine according to claim 1, wherein a residual magnetization of the second permanent magnet is larger than a residual magnetization of the first permanent magnet.

6. The rotary electric machine according to claim 1, wherein:
a recoil permeability of the first permanent magnet is 1.1 or more; and
a recoil permeability of the second permanent magnet is less than 1.1.

7. The rotary electric machine according to claim 1, wherein a composition formula of the first permanent magnet is RpFeqMrCutCo 100-p-q-r-s-t in which:
R is at least one element selected from rare earth elements;
Fe is the element iron;
M is at least one element selected from titanium, zirconium, and hafnium;
Cu is the element copper;
Co is the element cobalt; and
p, q, r, s and t are numbers respectively satisfying 10.8≤p≤11.6, 25≤q≤40, 0.88≤r≤4.5, and 0.88≤t≤13.5 when each of p, q, r, s and t is expressed as an atomic composition percentage.

8. The rotary electric machine according to claim 1, wherein a composition formula of the second permanent magnet is RsTuBv in which:
R is at least one element selected from rare earth elements;
T is formed of iron and at least one element selected from cobalt, nickel, copper, aluminum, zinc, silicon, gadolinium, and gallium;
B is the element boron; and
s and v are numbers respectively satisfying 10≤s≤25, 2≤q≤20, and u=100−s−v, when each of s and v is expressed as an atomic composition percentage.

9. The rotary electric machine according to claim 1, wherein the first permanent magnet is disposed on an outer circumferential side of the rotor core with respect to the second permanent magnet.

10. A vehicle including the rotary electric machine according to claim 1.
